(19) United States
(12) Patent Application Publication
(10) Pub. No.: US 2005/0156979 A1
(43) Pub. Date: Jul. 21, 2005

(54) METHOD AND DEVICE FOR CALIBRATING DRIVING SIGNALS OF A PRINTHEAD

(76) Inventor: Wen-Chi Chang, Tai-Chung Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,667

(22) Filed: Jul. 28, 2004

(30) Foreign Application Priority Data
Jan. 19, 2004 (TW) 093101411

(51) Int. Cl. B41J 29/393

(52) U.S. Cl. 347/19

(57) ABSTRACT

A method and a device are used for calibrating driving signals of a printhead. The method includes utilizing a plurality of driving signals for respectively heating the printhead to print a plurality of test patterns on a print medium, selecting a test pattern with better printing quality out of the test patterns, determining a driving signal corresponding to the test pattern with better printing quality, and utilizing the driving signal to drive the printhead to print data.

### BACKGROUND OF INVENTION

1. Field of the Invention

The present invention provides a method and a device for calibrating driving signals of a printhead, and more particularly to a method and a device that prints a test pattern for rectifying driving signals of a printhead.

2. Description of the Prior Art

Inkjet printers provide good printing quality at a fair price and as a result, have become the most popular printing equipment. With the quick advancement of technology, better printing quality has been a target that information industrial circles work for. Generally speaking, an inkjet printer utilizes a carriage holding an inkjet printhead. The inkjet printhead utilizes a heating device (ex. heating resistors) to heat the ink instantaneously for generating bubbles that further jets the ink out. As a result, the consistency of the quantity of the ink jetted out has a great influence on the print quality, especially in the quality of a high-resolution inkjet printhead. In general, an inkjet printhead comprises a nozzle layer and a chip. The nozzle layer comprises a plurality of nozzles, and the chip comprises a plurality of heating devices and driving circuits. Each nozzle corresponds to a heating device and a driving circuit. The driving circuit is utilized to control the current that passes through the heating device for heating the ink and generating the bubbles; when the bubbles are generated, the ink is pushed through the nozzle. The ejected quantity is related to the energy that the heating devices give to the ink. In order to control the energy that the heating devices give to the ink to maintain the consistency of the ejected quantity through each nozzle, not only is the consistency of the size of each nozzle is considered, but also the consistency of the circuit characteristic of each heating device and of each driving circuit when they are manufactured is considered.

As known by those skilled in the art, the inkjet printer has to provide a predetermined amount of energy to the ink, which then causes a proper quantity of ink to be ejected through the nozzle. In other words, the inkjet printer has to output a proper driving signal so that the ink is heated to the predetermined energy. If the energy of heating the ink is not enough to heat the ink to the predetermined energy, the ejecting speed of the ink through the nozzle could be so slow that the ink diverges from the predetermined position when the ink arrives at the printing medium, hence making the print quality bad. Furthermore, if the energy used to heat the ink in the inkjet printer is too low, it could also cause a reduction in the ejected quantity of the ink through the nozzle, thereby worsening the print quality. On the other hand, if the energy for the heating ink in the inkjet printer is much more than the predetermined energy, it could make the temperature of the heating resistor too high, thereby lowering its life. If the heating resistor is ineffective, it is possible that the inkjet could no longer be used. Additionally, if the energy of heating the ink in the printer is too high, it will also slow the ejecting speed of the ink through the nozzle. Therefore, the print quality is bad. From the above, one can see that how an inkjet printer outputs a driving signal for the heating resistor to provide the proper energy to the ink has become an important problem.

Generally speaking, the driving signal used for the inkjet printer according to the prior art is fixed. As a result, under the prior art, the cartridge to be used in the inkjet printer must be set up in a way that the inkjet printer can correctly heat the ink in the cartridge for ejecting the demanded ink according to the driving signal. However, for an inkjet printer in the prior art, the cartridge is a replaceable device. Because the driving signal mentioned above corresponds to a fixed waveform, the characteristic of each cartridge (ex: the value of the heating resistors) must be very close so that each cartridge that is to be used in the same inkjet printer in the prior art is close in terms of print quality. Consequently, the quality control of the cartridges must be at a high level in order to eliminate bad cartridges from production. Therefore, the production costs is raised because of the higher quality needs. Moreover, the devices of the cartridge have unavoidable errors when produced. To sum up, the fixed driving signals provided by the jet printer may not be the best driving signals for the inkjet printheads of each cartridge, meaning that the inkjet printer in the prior art cannot achieve the best print quality when executing the printing operation.

### SUMMARY OF INVENTION

It is therefore a primary objective of the claimed invention to provide a method and a device that prints a test pattern for rectifying driving signals of a printhead to solve the above-mentioned problem.

According to the claimed invention, a method for calibrating driving signals of a printhead is disclosed. The method comprises utilizing a plurality of test driving signals for printing a plurality of test patterns on a printing medium wherein each test driving signal drives the printhead to print one of the test patterns, selecting a test pattern with the optimal print quality from the test patterns, determining an optimal driving signal corresponding to the test pattern with the optimal print quality, and utilizing the optimal driving signal to drive the printhead to print data.

Also according to the claimed invention, a printing device that calibrates the driving signals of a printhead is disclosed. The printing device comprises a printhead with a plurality of nozzles, and a controller connected to the printhead that is used to utilize a plurality of driving signals for printing a plurality of test patterns on a printing medium with each test driving signal causing the printhead to print a test pattern. The printing device selects an optimal driving signal that corresponds to the test pattern with the optimal print quality from the plurality of test patterns and then utilizes the optimal driving signal to drive the printhead to print data.

The claimed method for calibrating driving signals calibrates the voltage level and pulse width of the driving signal respectively and dynamically according to the hardware characteristic of different ink-jet printheads. Therefore, when a cartridge of an ink-jet printer is changed, the claimed method will start to calibrate every parameter of the driving signal that is used for the printhead of the added cartridge so that the ink-jet printhead can utilize the calibrated driving signal to provide the best print quality during an actual printing operation.

These and those objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a function block diagram of an inkjet printer that utilizes the method for calibrating driving signals according to the present invention.

FIG. 2 is a waveform diagram of a driving signal shown in FIG. 1.

FIG. 3 is a first operation diagram illustrating a method of calibrating driving signals according to the present invention.

FIG. 4 is a diagram of a close-up view of oblique lines shown in FIG. 3.

FIG. 5 is a diagram of the oblique lines printed in different swaths shown in FIG. 3.

FIG. 6 is a second operation diagram illustrating the method of calibrating driving signals according to the present invention.

FIG. 7 is a diagram of a close-up view of color-blocks shown in FIG. 4.

FIG. 8 is a waveform diagram of the third kind of test driving signals used in the method for calibrating driving signals according the present invention.

FIG. 9 is a waveform diagram of the fourth kind of test driving signals used in the method for calibrating driving signals according the present invention.

FIG. 10 is the third operation diagram illustrating the method for calibrating driving signals according to the present invention.

### DETAILED DESCRIPTION

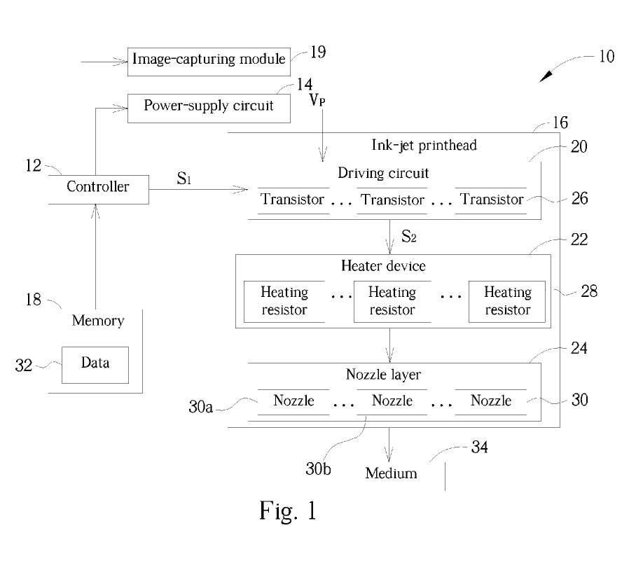

Please refer to FIG. 1. FIG. 1 is a function block diagram of the inkjet printer that utilizes the method for calibrating driving signals according to the present invention. The inkjet printer 10 comprises a controller 12, a power-supply circuit 14, an inkjet printhead 16, a memory 18, and an image-capturing module 19. The inkjet head 16 comprises a driving circuit 20, a heating device 22, and a nozzle layer 24, wherein the driving circuit 20 is used for driving the heating device 22 to eject ink drops through the nozzle layer 24. The driving circuit 20 comprises a plurality of transistors 26. The heating device 22 comprises a plurality of heating resistors 28. The nozzle layer 24 comprises a plurality of nozzles 30. Further, the memory 18 is used as a buffer for storing the data 32 that will be printed later. For example, the data 32 is the print data that a computer outputs, so the controller 12 drives the nozzles 30 of the inkjet head 16 on a medium 34 to execute the printing related operation according to the data 32. It means that the inkjet printer 10 drives the nozzles 30 to print data on the medium 34 by heating the corresponding heating resistors 28 mentioned above. In this embodiment, the image-capturing module 19 (such as a CCD sensor device) is used for detecting the printing patterns on the medium 34 to produce the corresponding images. The function of the image-capturing module 19 will be explained later.

When the inkjet printer 10 starts a printing operation, the controller 12 first loads the data 32 temporarily stored in the memory 18 (such as a DRAM) and then generates the control signal S1 to the driving circuit 20 for controlling whether the transistor 26 turns on or off according to the data 32. For example, the transistor 26 is a NMOS, and the control signal Sl is the gate of the input transistor, so the control signal S1 can control the voltage level of the transistor 26 to determine whether the channel is formed or not. Furthermore, the power-supply circuit 14 is electrically connected to the drain of the transistor 26, and the heating resistor 26 is electrically connected to the source of the transistor 26, so when the transistor is turned on by the control signal S1, the driving circuit 20 generates a driving signal S2 to the heating device 22. It means that the driving voltage Vp provided by power-supply circuit 14 drives the heating resistor 28 through the driving signal S2. At last, when the heating resistor 28 drives the ink to reach a predetermined energy, the ink can be ejected through the corresponding nozzle 30. As mentioned in the above, the heating time of the driving signal S2 applied to the heating resistor 28 is controlled by the control signal S1, and the heating efficiency of the driving signal S2 applied to the heating resistor 28 is controlled by the driving voltage Vp. In another words, the control signal S1 and the driving voltage Vp impact the waveform of the driving signal S2. Additionally, as it is known, the driving signal S2 further comprises a pre-heat pulse that is used for maintaining the consistency of the output ink ejected through different nozzles.

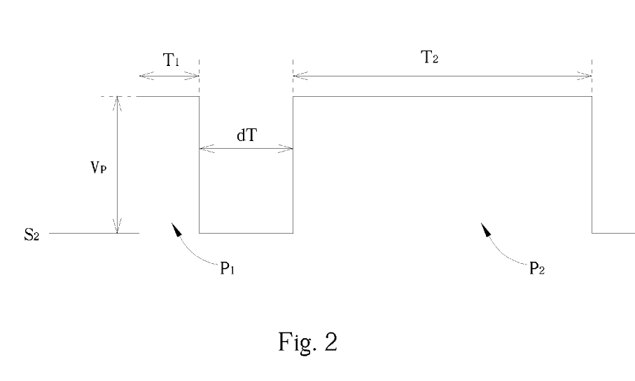

Please refer to FIG. 2, which is a waveform diagram of the driving signal S2 shown in FIG. 1. In FIG. 2, the driving signal S2 comprises a pre-heat pulse P1 and a main driving pulse P2 wherein the time duration T1 of the pre-heat pulse P1 is shorter than the time duration T2 of the main driving pulse P2, and a time interval dT is between the pre-heat pulse P1 and the main driving pulse P2. As mentioned in the above, the voltage level of the driving signal S2 is controlled by the driving voltage Vp outputted by the power-supply device 14, so the voltage levels of the pre-heat pulse P1 and the main driving pulse P2 both correspond to the driving voltage Vp. If the time duration T2 of the main driving pulse P2 is too long, the heating resistor 28 provides too much energy to the ink. And if the time duration T2 of the main driving pulse P2 is too short, the heating resistor 28 cannot provide enough energy to the ink. If the time duration T1 of the pre-heat pulse P1 is too long, the bubbles of the ink are not stable to impact the size of the drops of output ink ejected through the nozzles. On the contrary, if the time duration T1 of the pre-heat pulse P1 is too short, the effect of the pre-heating is not good. Further, if the time interval dT between the pre-heat pulse P1 and the main driving pulse P2 is too short, the pre-heat pulse P1 and the main driving pulse P2 are regarded as one pulse so that the heating resistor 28 is driven continuously during the time duration T1+T2 meaning that the heating resistor 28 overheats the ink.

To put the above together, if the waveform of the driving signal S2 is not good, the ink-jet head cannot print a pattern with good print quality on a printing medium. Because time duration T1, time duration T2, time interval dT, and driving voltage Vp all impact the waveform of the driving signal S2, and the driving signal S2 is generated by the controller 12 controlling the power-supply circuit 14 and the inkjet head 16, the method for calibrating the driving signal in the invention can utilize the controller 12 to control the time duration T1, time duration T2, time interval dT, and driving voltage Vp for generating different driving signals S2 to drive the inkjet head 16 to form a plurality of test patterns on the medium 34 so that the best setting of the inkjet head 16 can be determined. The operation is as follows.

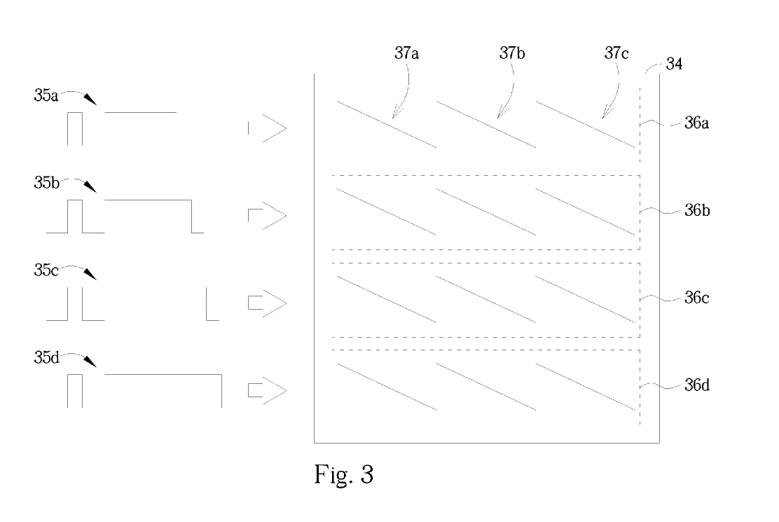

Please refer to FIG. 3, which is the first operation diagram of the method for calibrating driving signals according to the present invention. The inkjet head 16 is driven by different test driving signals 35a, 35b, 35c, and 35d, all of which have different waveforms, and separately prints a test pattern on a plurality of swaths 36a, 36b, 36c, and 36d on the medium 34. The test driving signals 35a, 35b, 35c, and 35d are the first kind of the test driving signals of the method for calibrating driving signals according to the present invention. As shown in FIG. 3, the test patterns are three oblique lines 37a, 37b, and 37c wherein the three oblique lines 37a, 37b, and 37c correspond to different colors. For example, the inkjet printer 10 is a color printing device. It means the cartridge of the inkjet printer 10 comprises a cyan ink, a magenta ink, and a yellow ink. The cartridges of the jet printer 10 utilize the CMY color system to print color patterns. In the embodiment, three oblique lines 37a, 37b, and 37c respectfully correspond to the ink ejected through a cyan-ink nozzle, a magenta-ink nozzle, and a yellow-ink nozzle.

As shown in FIG. 3, the pre-heat pulses of each test driving signal 35a, 35b, 35c, and 35d have the same time duration, the time interval between the pre-heat pulse and the main driving pulse is equal, and the power-supply circuit 14 provide the same driving voltage Vp to each driving signal 35a, 35b, 35c, and 35d. The main difference among the test driving signals lies in the time duration of the main driving pulses of each test driving signal 35a, 35b, 35c, and 35d. As shown in FIG. 3, the time duration of test driving signal 35a is the shortest, and the time duration of test driving signal 35d is the longest. Therefore, the method for calibrating the driving signal according to the invention is: selecting the test pattern that has the optimal print quality from the four test patterns on the swaths 36a, 36b, 36c, and 36d and then utilizing the driving signal with the optimal test pattern to be the optimal driving signal of the ink-jet head from among all the test driving signals 35a, 35b, 35c, and 35d.

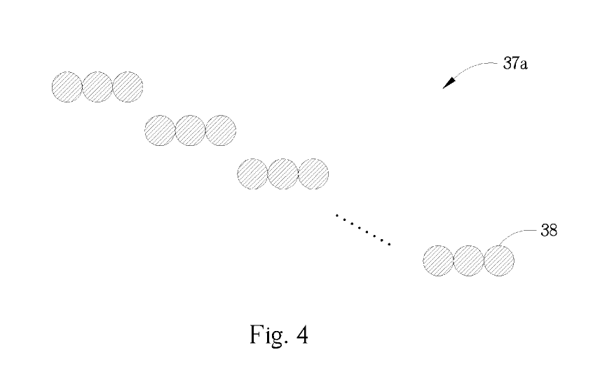

Please refer to FIG. 4, which is a diagram of a close-up view of the oblique line 37a shown in FIG. 3. The oblique line 37a is actually formed by a plurality of ink drops 38. Three drops of ink 38 are outputted by a nozzle 30 of the inkjet head 16, which is driven by the test driving signal 35a, to form a short horizontal line. Because the test driving signal 35a continuously drives the nozzle 30 of the inkjet printhead 16 to output three ink drops 38 to form a short horizontal line, a series of short horizontal lines are formed. As shown in FIG. 4, when all the short horizontal lines are combined, an oblique line is formed as shown in FIG. 3. The oblique lines 37b, and 37c are both formed in the swath 36a according to the same operation. In addition, the oblique lines in the other swaths 36b, 36c, and 36d are also formed according to the same operation. In this way, the best driving signal of the ink-jet printhead 16 can be determined by comparing the test patterns formed on the swaths 36a, 36b, 36c, and 36d.

For example, if the time duration of the main driving pulse is not long enough, the heating resistor 28 cannot provide enough energy for the ink drops meaning that the ink drops cannot ejected through the nozzle 30, the size of ink drops is too small, or the ink drops reach the medium 34 late, deviating by a noticeable degree from the pre-determined position. Because of the deviation, the oblique lines 37a, 37b, and 37c may change shape by becoming a distorted line or a broken-off line. Similarly, if the time duration of the main driving pulse is too long, the heating resistor 28 provides more energy than what the ink drops need to be ejected through the nozzle 30. This causes either the size of the ink drops ejected through the nozzle to be too big, or the ink drops to reach the medium 34 too early, thereby deviating the predetermined position. Early deviations also make the oblique lines 37a, 37b, and 37c change shape by becoming a distorted line or a broken-off line.

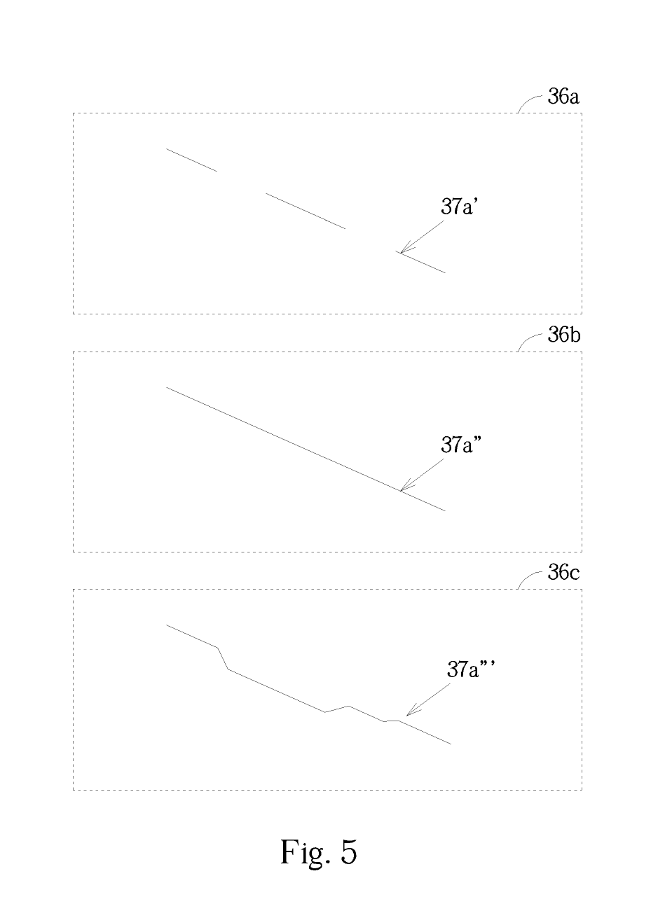

Please refer to FIG. 5, which is a diagram of the oblique lines 37a, 37a, and 37a″ printed in different swaths 36a, 36b, and 36c shown in FIG. 3. FIG. 5 only shows three oblique lines 37a, 37a″, and 37a″″ for the purpose of easier explanation. As shown in FIG. 5, because the heating resistor 28 cannot provide enough energy to the ink drops for ejection through the nozzle 30, the oblique line 37a on the swath 36a is less continuous than the oblique line 37a″ on the swath 36b. Further, because the heating resistor 28 provide more energy than that the ink drops needed for ejection through the nozzle 30, the oblique line 37a″″ on the swath 36c is much more distorted than the oblique line 37a″ on the swath 36b. Consequently, the driving signal corresponding to the test pattern on swath 36b is chosen to be the driving signal of the inkjet printhead 16.

In other words, the method for calibrating driving signals according to the present invention can be that users judge the result of the test patterns on the swaths 36a, 36b, 36c, and 36d to select a test driving signal that has the smallest ink-drop-shift, which corresponds to the test oblique line that suffers the least from distortion and break-off, to be the driving signal of the inkjet printer 10 for printing data.

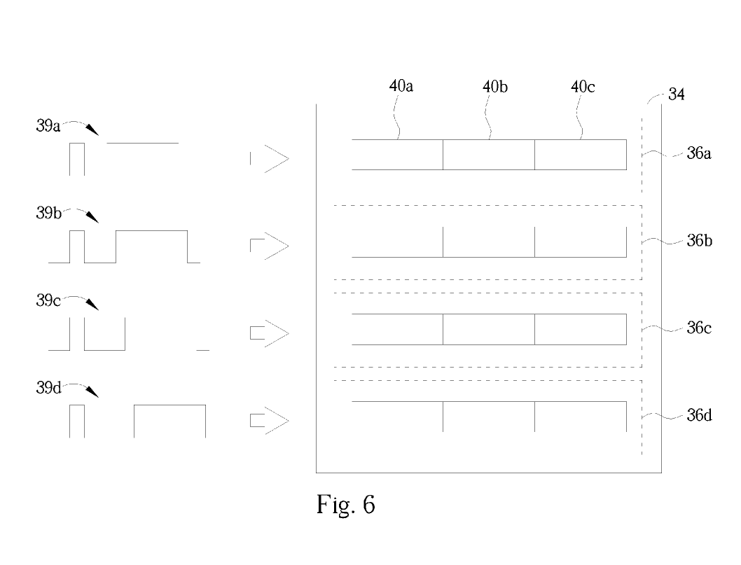

Please refer to FIG. 6, which is the second operation diagram illustrating the method for calibrating driving signals according to the present invention. The test driving signals 39a, 39b, 39c, and 39d, which all have different waveforms, each take turns to drive the inkjet printhead to print a test pattern on a swath 36a, 36b, 36c, and 36d; the test driving signals 39a, 39b, 39c, and 39d are the second kind of test driving signals of the method for calibrating driving signals according to the present invention. As shown in FIG. 6, the test patterns are three color-blocks 40a, 40b, and 40c wherein each of the three color-blocks 40a, 40b, and 40c are respectfully correspond to a different color. For example, three color-blocks 40a, 40b, and 40c are separately corresponding to the cyan-ink nozzle, the magenta-ink nozzle, and the yellow-ink nozzle. As one can see, the time duration of all pre-heat pulses and the main driving pulses of the test driving signals 39a, 39b, 39c, and 39d are the same, and the power-supply circuit provides the same driving voltage Vp to each test driving signal 39a, 39b, 39c, and 39d. The main difference lies in that the time interval dT between the pre-heat pulse and the main driving pulse of the each driving signal 39a, 39b, 39c, and 39d are different. As shown in FIG. 6, the time interval dT between the pre-heat pulse and the main driving pulse of the test driving signal 39a is the shortest, and the time interval dT between the pre-heat pulse and the main driving pulse of the test driving signal 39d is the longest. The method for calibrating driving signals according to the present invention is determining the optimal driving signal of the inkjet printhead 16 from all the test driving signals 39a, 39b, 39c, and 39d by judging the print results of the test patterns on the swaths 36a, 36b, 36c, and 36d.

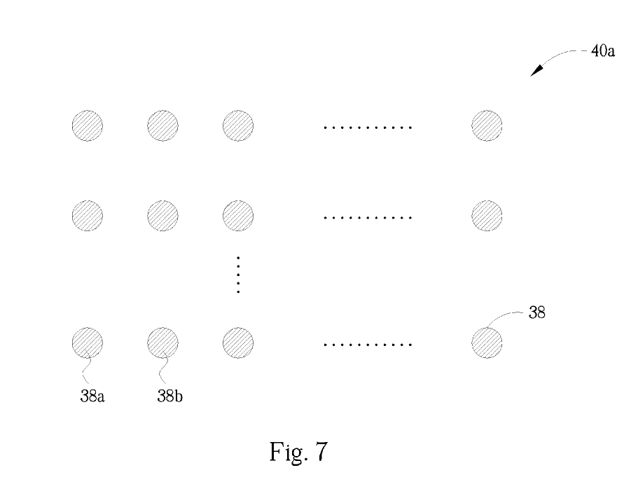

Please refer to FIG. 7, which is a diagram of a close-up view of the color-block 40a shown in FIG. 4. The color-block is actually formed by a plurality of ink drops. Two adjacent ink drops 38a, and 38b in the color-block is ejected through the two different nozzles 30a and 30b of the three distant nozzles 30 of the inkjet printhead 16; the test driving signal 39a separately drives two non-adjacent nozzles 30a and 30b of the inkjet printhead 16 to output the ink drops 38 so that the ink drops 38 out-putted by non-adjacent nozzles 30 can be used for detecting the distribution of the ink drops 38 on the color-block 40a. The color-blocks 40b and 40c are formed on the swath 36a according to the same operation. Further, the color-blocks on the other swaths 36b, 36c, and 36d are formed according to the same operation. The print results of the test patterns formed on the swaths 36a, 36b, 36c, and 36d are then judged to select the test pattern that has the optimal print quality to be the optimal driving signal of the inkjet printhead 16 from among all the driving signals 35a, 35b, 35c, and 35d.

The time interval dT affects the print quality in the following ways. If the time interval dT is too short, the pre-heat pulse P1 causes the main driving pulse P2 to be a wider printing signal. Consequently, the actual positions of the ink drops 38 will shift from the ideal positions, meaning that the ink drops 38 will spread on the color-block 40a irregularly. If the time interval dT is too long, the pre-heating will not be long enough. This results in the sizes of the ink drops changing, which thereby generates different consistency in colors and results in making the color-uniformity of color-block 40a poor. Therefore we determine which test driving signal is the optimal driving signal by judging the sizes of the ink drops and the color-uniformity of the print result of the color-block 40, wherein the driving signal that we select will be used for the driving signal that is used in the actual print operation of the jet printer 10.

Additionally, the driving signals 39a, 39b, 39c, and 39d shown in FIG. 6 can be used to drive the ink-jet printhead 16 to generate the test patterns (the oblique lines 37a, 37b, and 37c) shown in FIG. 3. The users then select the test driving signal that has the smallest deviation value (the oblique line with the least apparent break-off and the smallest degree of the shape-change and distortion) according to the deviation value of shifting the ideal position of the ink drops of the test patterns. The driving signal selected by the users is used for the driving signal of the jet printer 10 in the actual printing operation. It can also accomplish the aspect for calibrating the driving signals according to the present invention.

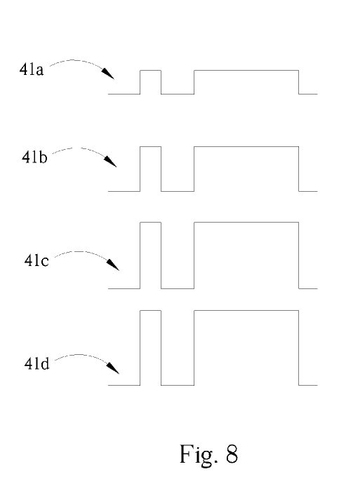

Please refer to FIG. 8, which is a waveform diagram of the third kind of test driving signals used in the method for calibrating driving signals according the present invention. In the FIG. 8, different test driving signals 41a, 41b, 41c, and 41d drive the inkjet printhead 16 to conduct the operation of calibrating driving signals. As one can see, each time duration of pre-heat pulse of test driving signals 41a, 41b, 41c, and 41d is the same, the time interval of between the pre-heat pulse and the main driving pulse is the same, and the time duration of the main driving pulse is the same. The main difference lies in that the controller 12 drives the power-supply circuit 14 to provide different driving voltages Vp to each driving signal 41a, 41b, 41c, and 41d. As shown in FIG. 8, the voltage level of test driving signal 41a is the lowest, and the voltage level of test driving signal 41d is the highest. The test driving signals 41a, 41b, 41c, and 41d can be used to drive the ink-jet printhead 16 to generate the test patterns (oblique lines 37a, 37b, and 37c) shown in FIG. 3. The users then select the test driving signal that has the smallest deviation value (the oblique line with the least apparent break-off and the smallest degree of the shape-change and distortion) according to the value of shifting from the ideal position of the ink drops of the test patterns. The driving signal selected by users is used for the driving signal of the jet printer 10 in the actual printing operation.

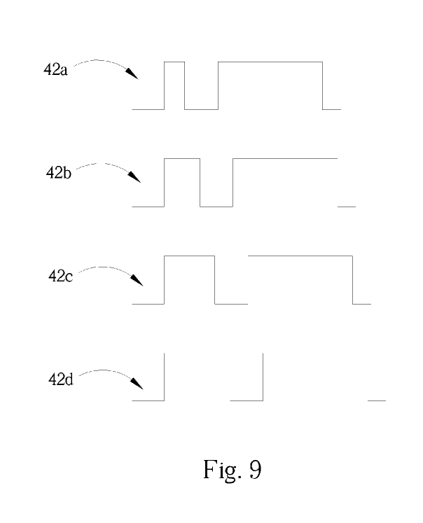

Please refer to FIG. 9, which is a waveform diagram of the fourth kind of test driving signals used in the method for calibrating driving signals according the present invention. In FIG. 9, different driving signals 42a, 42b, 42c, and 42d drive the ink-jet printhead 16 to conduct the operation of calibrating the driving signals. As one can see, each time interval between the pre-heat pulse and the main driving pulse of each of the test driving signals 42a, 42b, 42c, and 42d is the same, the time duration of the main driving pulse is the same, and the power-supply circuit 14 provides the same driving voltage Vp to each driving signal 42a, 42b, 42c, and 42d. The main difference lies in that the time durations of the pre-heat pulses are different. As shown in FIG. 9, the pre-heat pulse of the test driving signal 42a is shortest, and the pre-heat pulse of the test driving signal 42d is longest. The test driving signals 42a, 42b, 42c, and 42d can be used to drive the ink-jet printhead 16 to generate the test patterns (the color-blocks 40a, 40b, 40c) shown in FIG. 6. The users can then select the driving signal of the inkjet printer 10 in the actual printing operation used for printing a data according to the color-uniformity, the sizes of ink drops, and the concentration of colors.

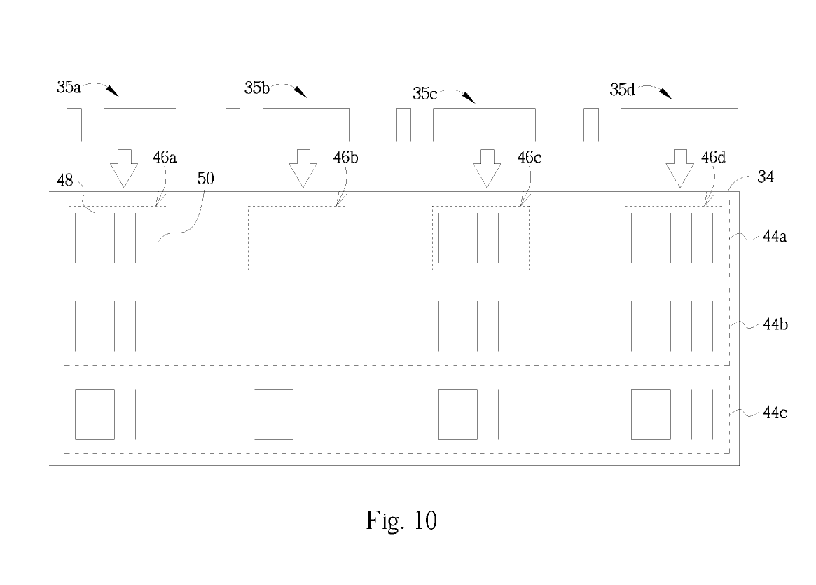

Please refer to FIG. 10, which is the third operation diagram illustrating the method for calibrating driving signals according to the present invention. The inkjet print-head 16 is driven by different test driving signals 35a, 35b, 35c, and 35d that have different waveforms and print a plurality of test patterns 46a, 46b, 46c, and 46d on the swath 44a, 44b, and 44c of the medium 34. As shown in FIG. 10, each test pattern 46a, 46b, 46c, and 46d comprises a color-block 48 and a plurality of lines 50 with the color-block 48 and a plurality of lines 50 being formed in the same way as that of the color-block 40a, 40b, and 40c and the color-block 37a, 37b, and 37c. Therefore, the detailed description will not be repeated. A reminder, the inkjet printer 10 in this embodiment is a color-printing device that utilizes the CMY color system to print color patterns. It means that the cartridge of the inkjet printer 10 comprises cyan ink, magenta ink, and yellow ink. Therefore, the test patterns of the three swaths 44a, 44b, and 44c correspond to the cyan ink, the magenta ink, and the yellow ink. The final result is that it can accomplish the task of separately calibrating the nozzles that the cyan ink, the magenta ink, and the yellow ink are ejected through.

As the mentioned above, in each of the test driving signals 35a, 35b, 35c, 35d, the main difference lies in that the time duration of the main driving pulse of each test driving signal 35a, 35b, 35c, 35d is different. If the time duration of the main driving pulse is not enough or too long, the heating resistor 28 cannot provide enough energy to the ink drops for ejection through the nozzle 30, meaning that the size of ink drops is too small and/or the ink drops shift too much from the pre-determined position when reaching the medium 34. Therefore, the line 50 may break-off because that the ink drops cannot leave the nozzle 30, or the line 50 may change shape because the position of the ink drops shifts. In other words, the method for calibrating driving signals according to the present invention can utilize the line 50 of each test pattern 46a, 46b, 46c, and 46d to detect the deviation value of the ink drops that shift from the ideal position and then select the test driving signal that has smallest deviation value (the line 50 has the smallest degree of the shape-change and distortion) to be the driving signal of the jet printer 10 in the actually printing operation for printing data.

Furthermore, the method for calibrating driving signals according to the present invention can also utilize the test driving signals 39a, 39b, 39c, and 39d shown in FIG. 6 to drive the inkjet printhead 16 for generating the test patterns 46a, 46b, 46c, and 46d shown in FIG. 10 and then select the optimal test driving signal to be the driving signal of the inkjet printer 10 in the actual printing operation for printing data according to the deviation value of the ink drops that shift from the ideal position of line 50(the degrees of shape-change and distortion of the line 50), the uniformity of color-block 48, the concentration of colors, or the size of ink drops of the test patterns 46a, 46b, 46c, and 46d. It can also accomplish the part of the method for calibrating driving signals according to the present invention.

Similarly, the method for calibrating driving signals according to the present invention can also utilize the test driving signals 41a, 41b, 41c, and 41d shown in FIG. 8 to drive the inkjet printhead 16 for generating the test patterns 46a, 46b, 46c, and 46d shown in FIG. 10 and then select the optimal test driving signal to be the driving signal of the inkjet printer 10 in the actual printing operation for printing data according to the deviation value of the ink drops that shifts from the ideal position of line 50(the degrees of shape-change and distortion of the line 50). It can also accomplish the part of the method for calibrating driving signals according to the present invention. Still yet, the method for calibrating driving signals according to the present invention can also utilize the test driving signals 42a, 42b, 42c, and 42d shown in FIG. 9 to drive the inkjet printhead 16 for generating the test patterns 46a, 46b, 46c, and 46d shown in FIG. 10 and then select the optimal test driving signal to be the driving signal of the jet printer 10 in the actually printing operation for printing data according to the uniformity of color-block 48, the concentration of colors, or the size of ink drops of the test patterns 46a, 46b, 46c, and 46d. It can also accomplish the part of the method for calibrating driving signals according to the present invention.

Please note that the test patterns utilized in the method for calibrating driving signals according to the present invention is not limited the color-blocks and lines. To be more specific, the method for calibrating driving signals according to the present invention can utilize other patterns as long as the degrees of shape-change and distortion in the test patterns and the uniformity of colors can be discerned by users and print quality of the test patterns can also be easily distinguished by users.

Moreover, the method for calibrating driving signals according to the present invention can also utilize other tools to assist users to select the optimal test driving signal. As shown in FIG. 1, the image-capturing module 19 can detect the print patterns on the medium 34 to generate the corresponding images. Therefore, the images can provide information that the controller 12 needs to execute image processing to analyze the print situation on the medium 34. For example, after the inkjet printhead 16 prints the test patterns, the image-capturing module 16 will start to capture a plurality of images corresponding to the plurality of test patterns. Then the controller 12 utilizes an image processing program to analyze the position of ink drops (the deviation value of the line of the test pattern), the size of the ink drops, and the concentration of the ink drops. Finally, the jet printer 10 can select the test pattern that has the best print quality according to the rules mentioned above and set the test driving signal corresponding to the test pattern with the optimal print quality to be the driving signal of the inkjet printhead 16 for completing the procedure of automatically calibrating the inkjet printer 10.

Compared to the prior art, the method for calibrating driving signals according to the present invention utilizes different test driving signals that have different wave-forms to drive an inkjet printhead on a medium for printing a plurality of test patterns and then selecting the test pattern that has the optimal print quality. Finally, the test driving signal corresponding to the test pattern with the optimal print quality is set to be the driving signal that the ink-jet printhead uses to print data. In other words, the method for calibrating driving signals according to the present invention calibrates the voltage level and pulse width of the driving signal separately and dynamically according to the hardware characteristic of an inkjet printhead. Therefore, when a cartridge of an inkjet printer is changed, the method calibrating the driving signals of the invention will start to calibrate every parameter of the driving signal that is used for the inkjet printhead of the added cartridge so that the inkjet printhead can utilize the calibrated driving signal to provide the best print quality in practical printing operation.

Those skilled in the art will readily observe that numerous modifications and alterations of the device may be made while retaining the teachings of the invention. Accordingly, the above disclosure should be construed as limited only by the metes and bounds of the append claims.

1. A method for calibrating a driving signal of a printhead comprising:
(a) respectively utilizing a plurality of test driving signals for driving the printhead to print a plurality of test patterns on a printing medium according to a test data;
(b) selecting a test pattern with an optimal print quality from the test patterns;
(c) determining an optimal driving signal corresponding to the test pattern with the optimal print quality; and
(d) utilizing the optimal driving signal to drive the printhead to print data.

2. The method of claim 1 wherein the printhead is an inkjet printhead, and in step (a), the printhead respectively prints the test patterns on a plurality of swaths.

3. The method of claim 2 wherein each of the test driving signals comprises a main printing pulse, and the main printing pulses of the test driving signals all have the same voltage level but different pulse widths.

4. The method of claim 2 wherein each of the test driving signals comprises a main printing pulse, and the main printing pulses of the test driving signals all have the same pulse width but different voltage levels.

5. The method of claim 2 wherein each of the test driving signals comprises a main printing pulse and a pre-heat pulse, the main printing pulses of the test driving signals all have the same pulse width, the pre-heat pulses of the test driving signals all have the same pulse width, and the main printing pulses of the test driving signals and the corresponding pre-heat pulses of the test driving signals correspond to different delay times.

6. The method of claim 2 wherein each of the test driving signals comprises a main printing pulse and a pre-heat pulse, the main printing pulses of the test driving signals all have the same pulse width, the main printing pulses of the test driving signals and the corresponding pre-heat pulses of the test driving signals correspond to the same delay time, and the pre-heat pulses of the test driving signals have different pulse widths.

7. The method of claim 2 wherein the test data corresponds to at least one straight line, and in step (b), the test pattern with the optimal print quality is selected according to deviation values between the test patterns and the straight line.

8. The method of claim 7 wherein each of the test patterns is used to show a plurality of first color straight lines, and in step (b), the test pattern that has a minimum deviation value of the first color straight lines is selected to be the test pattern with the optimal print quality.

9. The method of claim 2 wherein the test data corresponds to at least one block, and in step (b), the test pattern with the optimal print quality is selected according to uniformity of the test patterns, concentration of the test patterns, or size of ink drops within the test patterns.

10. The method of claim 2 wherein the test data corresponds to a plurality of blocks with different colors, and in step (b), the test pattern with the optimal print quality is selected according to uniformity of the test patterns, concentration of the test patterns, or size of ink drops within the test patterns.

11. The method of claim 1 wherein the printhead is an inkjet printhead, and in step (a), the printhead prints the test patterns on a swath of a printing medium.

12. The method of claim 11 wherein each of the test driving signals comprises a main printing pulse, and the main printing pulses of the test driving signals all have the same voltage level but different pulse widths.

13. The method of claim 11 wherein each of the test driving signals comprises a main printing pulse, and the main printing pulses of the test driving signals all have the same pulse width but different voltage levels.

14. The method of claim 11 wherein each of the test driving signals comprises a main printing pulse and a pre-heat pulse, the main printing pulses of the test driving signals all have the same pulse width, the pre-heat pulses of the test driving signals all have the same pulse width, and the main printing pulses of the test driving signals and the corresponding pre-heat pulses of the test driving signals correspond to different delay times.

15. The method of claim 11 wherein each of the test driving signals comprises a main printing pulse and a pre-heat pulse, the main printing pulses of the test driving signals all have the same pulse width, the main printing pulses of the test driving signals and the corresponding pre-heat pulses of the test driving signals correspond to the same delay time, and the pre-heat pulses of the test driving signals have different pulse widths.

16. The method of claim 11 wherein the test data corresponds to at least one straight line, and in step (b), the test pattern with the optimal print quality is selected according to the deviation values between the test pattern and the straight line.

17. The method of claim 2 wherein test data corresponds to at least one block, and in step (b), the test pattern with the optimal print quality is selected according to uniformity of the test patterns, concentration of the test patterns, or size of ink drops within the test patterns.

18. A printing device comprising:
a printhead comprising a plurality of nozzles; and
a controller electrically connected to the printhead for utilizing a plutality of driving signals to respectively drive at least a heating resistor of the printhead to print a plurality of test patterns on a printing medium;
wherein the printing device selects an optimal driving signal that corresponds to a test pattern with an optimal print quality, and utilizes the optimal driving signal to drive the printhead to print data.

19. The printing device of claim 18 wherein the printhead is an inkjet printhead.

20. The printing device of claim 18 further comprising an image-capturing module electrically connected to the controller for capturing a plurality of images corresponding to the test patterns, wherein the controller selects a test pattern from the test patterns to be the test pattern with the optimal print quality according to the images.

21. The printing device of claim 20 wherein the test pattern is capable of printing a plurality of first color straight lines, and the controller selects a pattern that has a minimum deviation value of the first color straight lines to be the test pattern with the optimal print quality.
